(19) United States
(12) Patent Application Publication
(10) Pub. No.: US 2007/0122788 A1
(43) Pub. Date: May 31, 2007

(54) Virtual teaching assistant

(75) Inventor: Robert Lee Stevens JR., Ellicot City, MD (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/287,651

(22) Filed: Nov. 28, 2005

(51) Int. Cl. G09B 7/00

(52) U.S. Cl. 434/323

(57) ABSTRACT

Methods and systems for instruction of students in a classroom environment using a Virtual Teaching Assistant. The method includes providing an assessment with at least one set of remediation criteria and communicating the assessment to a recipient. Next a response is received from the recipient and the response is compared with the remediation criteria. Based on the comparison a tutorial is assigned to the recipient.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Many problems in education today stem from overcrowded classrooms. One of the symptoms of an overcrowded classroom is a high student-to-teacher ratio, thus resulting in some students not receiving the requisite attention needed for success. Overcrowding in the classroom typically does not allow teachers to effectively monitor students that fall behind or do not fully grasp the topics on a daily basis. Some other times students that fall behind are not inclined to speak up or ask for help because they feel embarrassed to do so in front of their peers.

### SUMMARY

One approach to address an overcrowded classroom with a high student to teacher ratio is to create an environment where students are provided with individualized instruction from their teacher. One such environment may be accomplished using virtual technology in the classroom that allows for confidential interaction between students and teachers. Specifically, a Virtual Teaching Assistant (VTA) allows teachers to give, and students to receive, individualized instruction. The VTA allows teachers to monitor a student's progress and assess student comprehension. Further, the VTA allows teachers to prescribe individualized instruction based on the needs of each student. Still further, the VTA allows teachers to provide instruction in a confidential manner, thereby eliminating the possibility of embarrassing the student.

The VTA is an application that allows teachers to assess student comprehension and to automatically administer individualized instruction to a student who is in need of special attention. The VTA consists of two applications, a VTA Teacher application and a VTA Student application. The VTA Teacher application is used by a teacher to conduct an assessment and then measure the progress of the student. The VTA Student application is used by the student to receive and take the assessment and then to read a prescribed tutorial from the teacher via the VTA Teacher application.

The assessment consists of an Assessment Learning Resource and a Remediation Criteria Set. The Assessment Learning Resource is a reference to any form of the assessment. The assessment typically includes a quiz having one or more questions that require a response by the user. The Remediation Criteria Set is a group consisting of at least one Remediation Criteria Rule and at least one Tutorial Directive. The Tutorial Directive is evaluated to provide information about the assessment and also prescribes the individualized instructional content for the student. A Remediation Criteria Rule is a rule that is based on the student's response to an assessment question and is evaluated to a true/false value. The rules determine the instructional content type provided to students based on assessment responses.

### BRIEF DESCRIPTION OF THE DRAWINGS

FIG. 1 is a block diagram of a computing system environment;

FIG. 2 is a block diagram of a Virtual Teaching Assistant (VTA) component summary;

FIG. 3 is a flowchart illustrating an exemplary process for implementing the VTA;

FIG. 4 is a schematic screen shot showing a quiz overview portion of the VTA teacher application;

FIG. 5 is a schematic screen shot showing a quiz questions portion of the VTA teacher application;

FIG. 6 is a schematic screen shot showing a remediation rules portion of the VTA teacher application;

FIG. 7 is a schematic screen shot showing a browse function of the VTA teacher application;

FIG. 8 is a schematic screen shot showing a search function the of VTA teacher application;

FIG. 9 is a schematic screen shot showing a quiz administration portion the of VTA teacher application;

FIG. 10 is a schematic screen shot showing a pop-up dialog box;

FIG. 11 is a schematic screen shot showing a VTA student application with a suggested Tutorial Directive;

FIG. 12 is a schematic screen shot showing a report in the VTA teacher application; and

FIG. 13 is a schematic screen shot showing a report in the VTA student application.

### DETAILED DESCRIPTION

The present invention will be better understood from the detailed description provided below and from the accompanying drawings of various embodiments of the invention. The detailed description and drawings, however, should not be read to limit the invention to the specific embodiments. Rather, these specifics are provided for explanatory purposes that help the invention to be better understood.

Exemplary Operating Environment

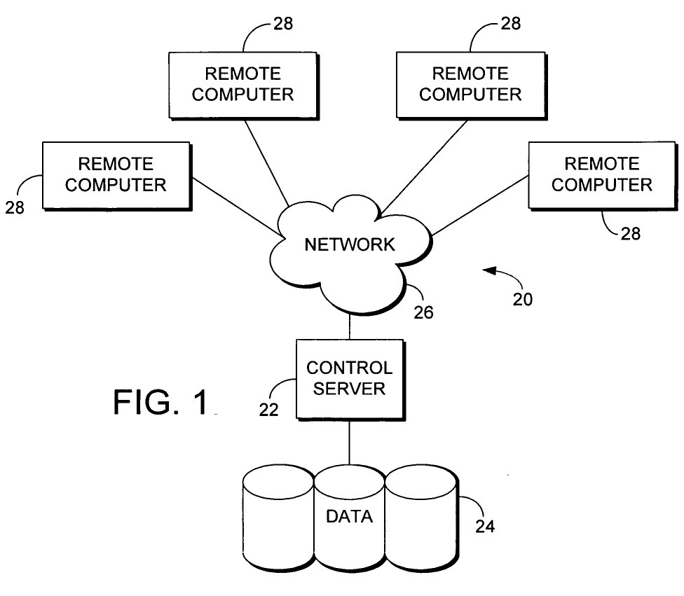

Referring to the drawings in general, and initially to FIG. 1 in particular, an exemplary computing system environment on which embodiments of the present invention may be implemented is illustrated and designated generally as reference numeral 20. It will be understood and appreciated by those of ordinary skill in the art that the illustrated computing system environment 20 is merely an example of one suitable computing environment and is not intended to suggest any limitation as to the scope of use or functionality of the invention. Neither should the computing system environment 20 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, programmable consumer electronics, network PCs, minicomputers, mainframe computers, distributed computing environments that include any of the above-mentioned systems or devices, and the like.

The present invention may be described in the general context of computer-executable instructions, such as program modules being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary computing system environment 20 includes a general purpose computing device in the form of a server 22. Components of the server 22 may include, without limitation, a processing unit, internal system memory, and a suitable system bus for coupling various system components, including a database cluster 24 with the server 22. The system bus may be any of several types of bus structures, including a memory bus or memory controller, a peripheral bus, and a local bus, using any of a variety of bus architectures.

The server 22 typically includes, or has access to, a variety of computer readable media, for instance, database cluster 24. Computer readable media can be any available media that may be accessed by server 22, and includes volatile and nonvolatile media, as well as removable and non-removable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 22. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 24, provide storage of computer readable instructions, data structures, program modules, and other data for the server 22.

The server 22 may operate in a computer network 26 using logical connections to one or more remote computers 28. Remote computers 28 may be located at a variety of locations in an education environment, for example, but not limited to, classrooms, libraries, etc. The remote computers 28 may be personal computers, servers, routers, network PCs, peer devices, other common network nodes, or the like, and may include some or all of the components described above in relation to the server 22. The devices can be personal digital assistants or other like devices.

Exemplary computer networks 26 may include, without limitation, local area networks (LANS) and/or wide area networks (WANs). Such networking environments are commonplace in offices, enterprise-wide computer networks, intranets, and the Internet. When utilized in a WAN networking environment, the server 22 may include a modem or other means for establishing communications over the WAN, such as the Internet. In a networked environment, program modules or portions thereof may be stored in the server 22, in the database cluster 24, or on any of the remote computers 28. For example, and not by way of limitation, various application programs may reside on the memory associated with any one or more of the remote computers 28. It will be appreciated by those of ordinary skill in the art that the network connections shown are exemplary and other means of establishing a communications link between the computers (e.g., server 22 and remote computers 28) may be utilized.

In operation, a user may enter commands and information into the server 22 or convey the commands and information to the server 22 via one or more of the remote computers 28 through input devices, such as a keyboard, a pointing device (commonly referred to as a mouse), a trackball, or a touch pad. Other input devices may include, without limitation, microphones, scanners, or the like. Commands and information may also be sent directly from a remote computers 28 to the server 22. In addition to a monitor, the server 22 and/or remote computers 28 may include other peripheral output devices, such as speakers and a printer.

Although many other internal components of the server 22 and the remote computers 28 are not shown, those of ordinary skill in the art will appreciate that such components and their interconnection are well known. Accordingly, additional details concerning the internal construction of the server 22 and the remote computers 28 are not further disclosed herein.

Virtual Teaching Assistant

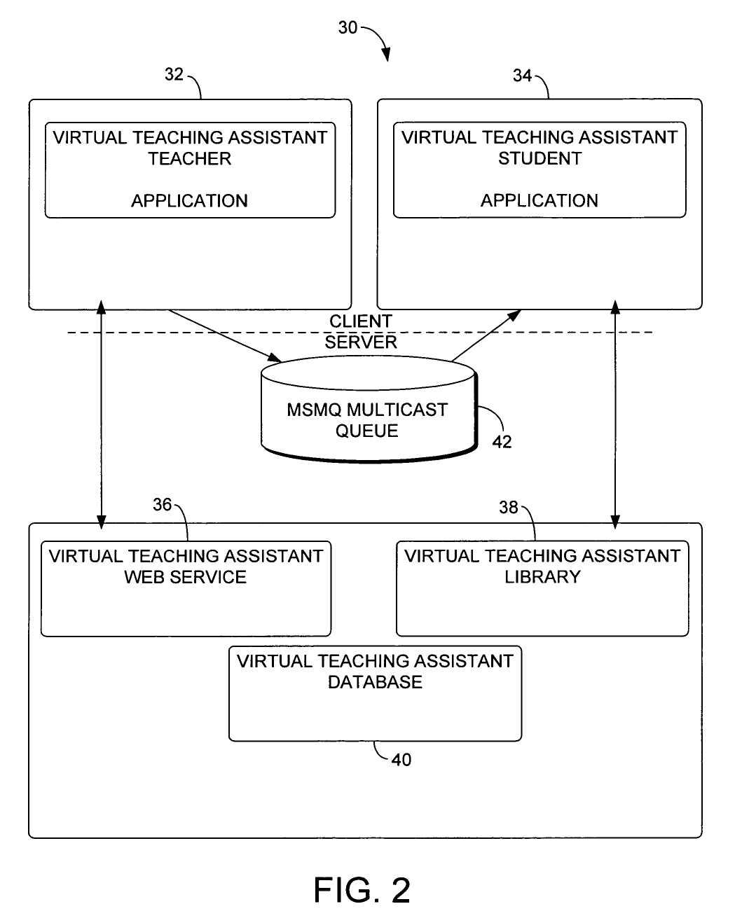

As shown in FIG. 2, a Virtual Teaching Assistant (VTA) 30 is an application that allows teachers to assess student comprehension and to automatically administer individualized instruction to students who are in need of special attention. The VTA 30 is primarily a set of desktop applications that allows teachers to perform an informal assessment of student comprehension for a limited subject matter and to prescribe additional learning resources for students who are in need. The VTA 30 helps a teacher provide individualized informational content to a student in response to the assessment. The VTA 30 consists of two applications, a VTA teacher application 32 and a VTA student application 34. These applications can be implemented on a graphical operating system, such as the WINDOWS family of operating systems from the Microsoft Corporation of Redmond, Wash. The VTA teacher application 32 is used by the teacher to conduct assessments and then measure the progress of the student. The VTA student application 34 is used by the student to receive and take the assessment and then to read a prescribed tutorial from the teacher via the VTA teacher application 32. The VTA, including both the VTA teacher application 32 and the VTA student application 34 may be used on the remote computers 28 shown in FIG. 1.

Referring again to FIG. 2, the VTA teacher application 32 and the VTA student application 34 utilize various other applications. When used in a Microsoft WINDOWS environment, these applications are also WINDOWS-based applications. It should, of course, be understood that these application can be designed and implemented based on other operating systems. The VTA teacher and the VTA student applications 32, 34 utilize a VTA Web Service 36, a VTA Library 38, and a VTA Database 40. An example of the VTA Database 40 is Microsoft SQL Server 2000 or 2005 database. An example of the VTA Web Service 36 is Microsoft Windows Server 2003 with IIS 6. Each of the VTA components 36, 38, and 40 are deployed in an environment that includes a Microsoft Message Queue Server (MSMQ) multicast queue 42. All of the above VTA components 36, 38, and 40 are available from the Microsoft Corporation of Redmond, Wash. It should be understood that other components of comparable functionality could also be used.

The VTA web service 36 is used to obtain data from the local school to determine the teacher's class schedule. If the teacher does not have a class section scheduled for the current local time, then the VTA web service 36 will disable the option to send the assessment to the class. The VTA web service 36 communicates with the VTA teacher and the VTA student applications 32, 34 to determine if a class section is scheduled and whether an assessment may be sent.

The VTA Library 38 is a class library that contains programmatic functions that are important to the functioning of the VTA web service 36, the VTA teacher application 32, and the VTA student application 34. The VTA Database 40 stores information about the quizzes that are sent to the classes.

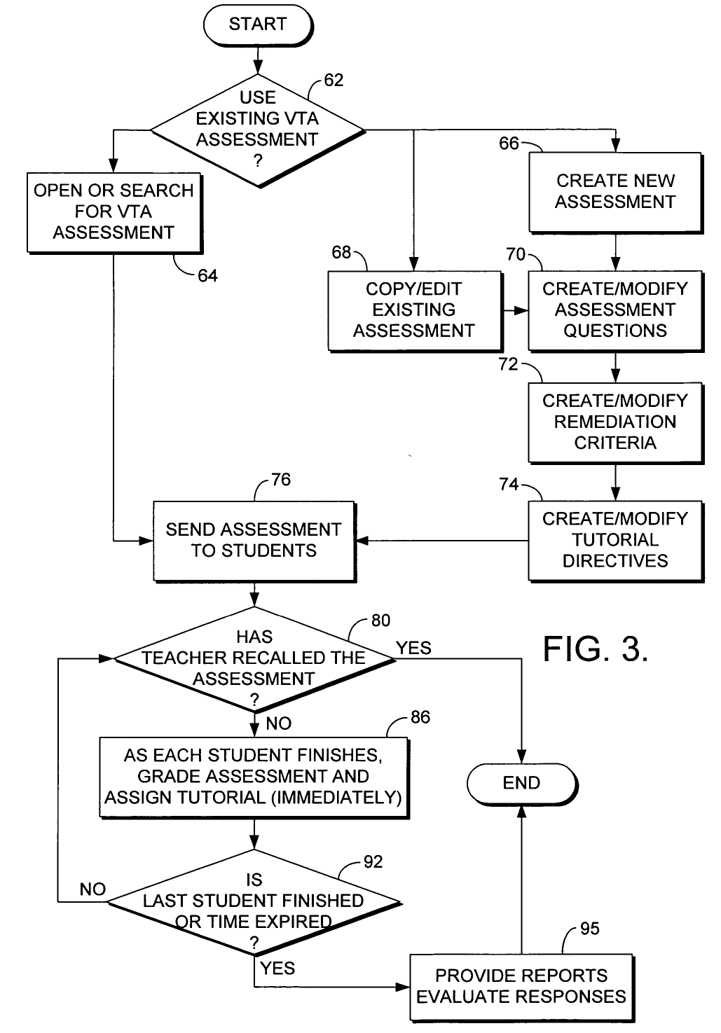

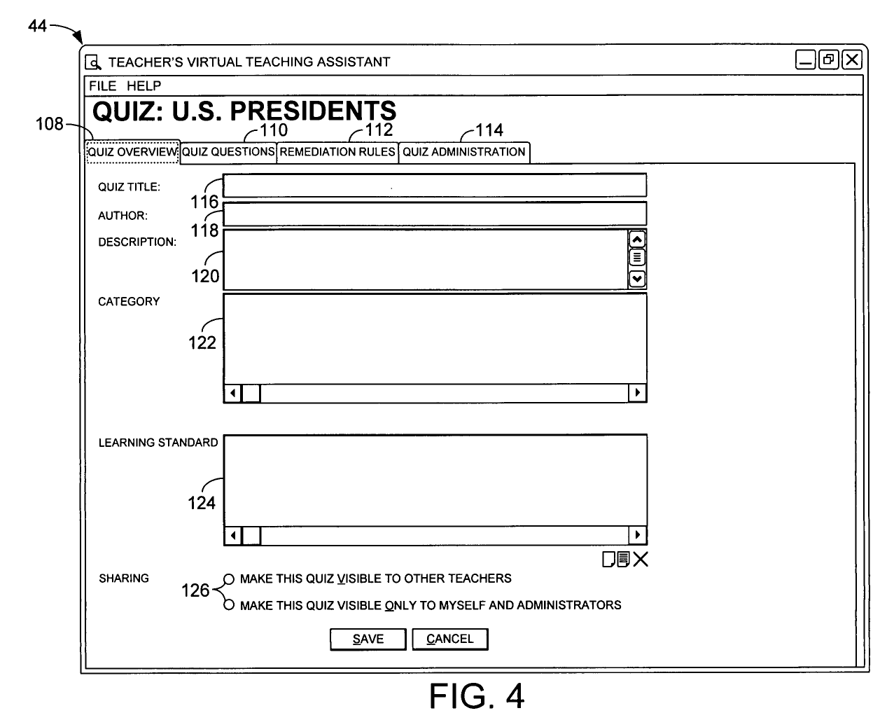

As shown in FIG. 3, a described method may be implemented using the VTA 30. First, a teacher at step 62 provides the assessment 44, shown in FIG. 3, that will be further discussed below. The teacher may search the VTA Database 40 for an existing assessment 44 at step 64. Alternatively, the teacher may either create assessment 44 at step 66 using the VTA teacher application 32 or copy and edit an existing assessment 44 from the VTA Database 40 at step 68. An example of an assessment 44 created using the VTA teacher application 32 is discussed below with reference to FIGS. 4-9. If the teacher has created an assessment 44, the teacher can publish the assessment 44 to the VTA database 40. Once the assessment 44 is published on the VTA Database 40, the assessment 44 is shared with other teachers. The assessment 44 is saved, for example, in the form of an XML document. The assessment 44 may be saved on the teachers local machine or

Once the assessment 44 is created, questions and rules may be created or modified by the teacher at step 70. The assessment 44 consists of an Assessment Learning Resource 46 and an Remediation Criteria Set 48, both of which will be further discussed below. The Remediation Criteria Set 48 is a group consisting of at least one Remediation Criteria Rule 52 and at least one Tutorial Directive 54. The teacher uses the VTA teacher application 32 to create the Assessment Learning Resource 46 at step 70. Next the teacher creates the Remediation Criteria Rules 52 at step 72 and the Tutorial Directives 54 at step 74. The Remediation Criteria Rules 52 and the Tutorial Directives 54 define what type of targeted instructional content should be provided to students.

At step 76, the teacher uses the VTA teacher application 32 to send the assessment 44 to the students. The VTA teacher application 32 uses the VTA Web Service 36 to determine whether the teacher has a class section assigned for the current local time. If no class section is assigned for the current local time, the application will disable the option to send the quiz to the class.

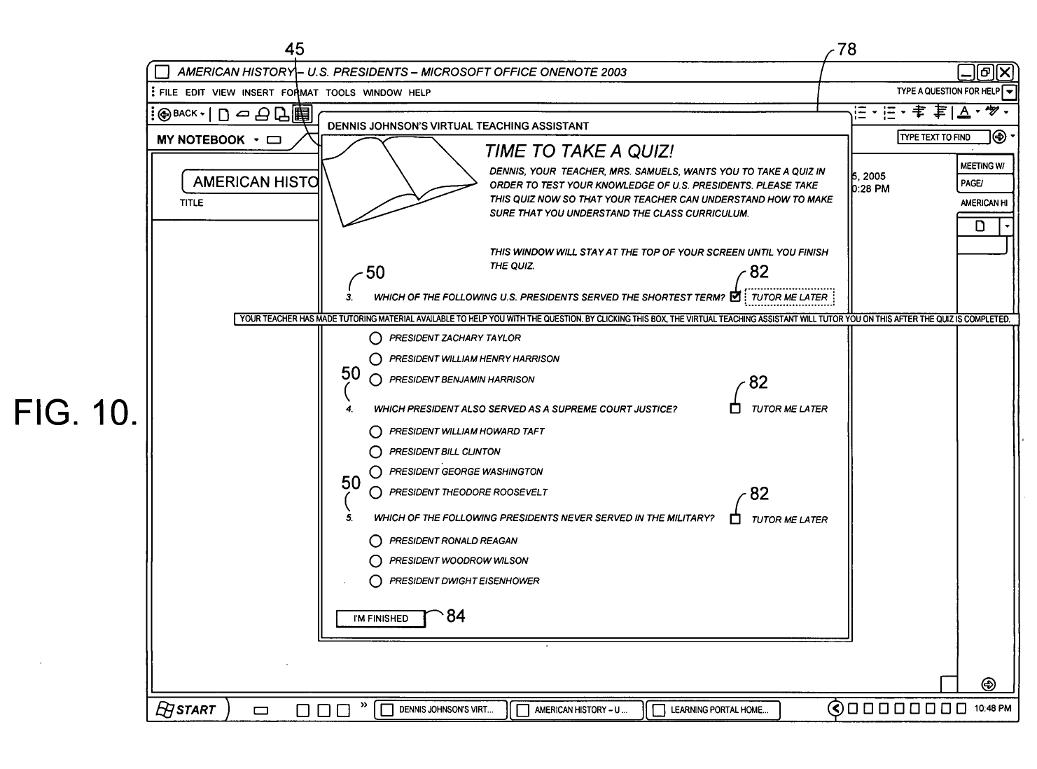

As shown in FIG. 10, once the assessment 44 has been sent at step 76, each student who is assigned to the teacher's current class section will be prompted with a dialog box 78 on their screen informing them that the teacher has assigned them a quiz 45 and that they need to take it now. The student will not have the ability to dismiss the quiz 45 until either they have completed it or the class ends. The teacher has the ability to recall the quiz 45 at step 80, in which case the application will disappear from the student's screen. The dialog box 78 contains a number of boxes 82 that may be checked by the student. The boxes 82 correspond to the Tutorial Directive 54 made available by the teacher in the VTA.

Once the student has completed the quiz 45, the student selects an “I'm finished” button 84 and the assessment 44 is returned to the teacher at step 86 via the VTA student application 36. Further, as each assessment 44 is completed at step 86, the VTA 30 will grade the assessment 44 comparing the student-provided answers with the stored answers in the VTA database 40.

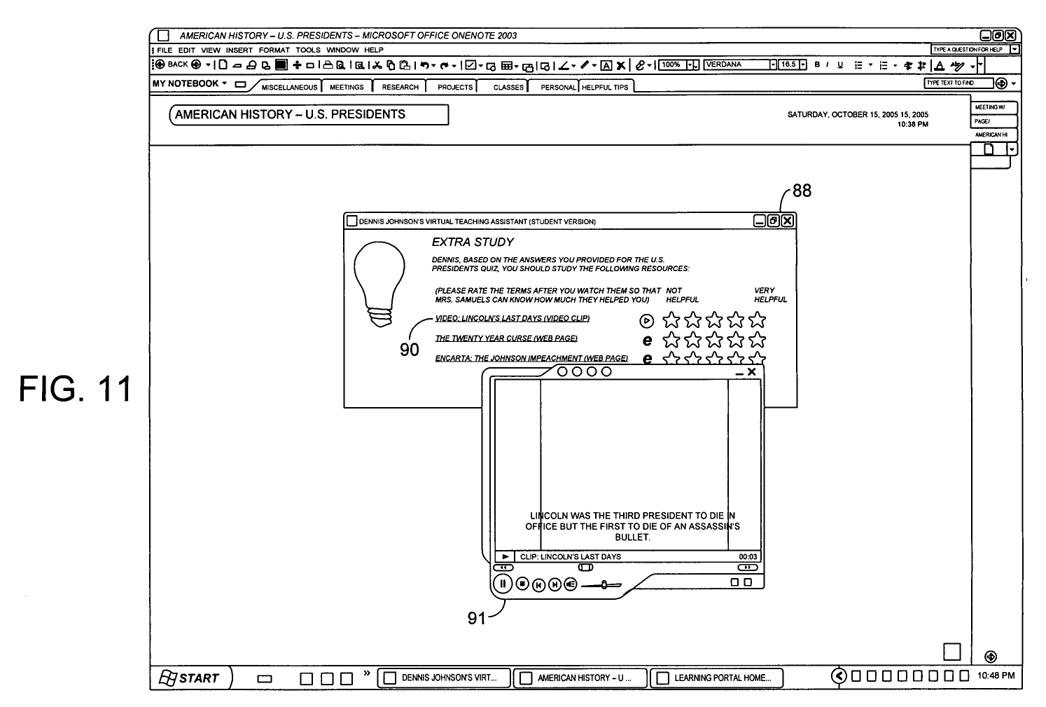

At step 86, the students who have been determined to need extra help based on the Remediation Criteria Set 48 will see a pop-up window 88, as shown in FIG. 11, appear on their screens. The pop-up window 88 will show links 90 to learning material that the student has been assigned. The student will select the link 90 and a tutorial 91 will appear on the screen. While a video tutorial is shown, it should be appreciated by one of ordinary skill in the art that any type of tutorial may be used. Once the student has completed the tutorial 91, he will comment on whether or not he found the material helpful.

Once each student is finished at step 92, the teacher and student will be presented with a report 94, 98 at step 95 as will be further discussed below.

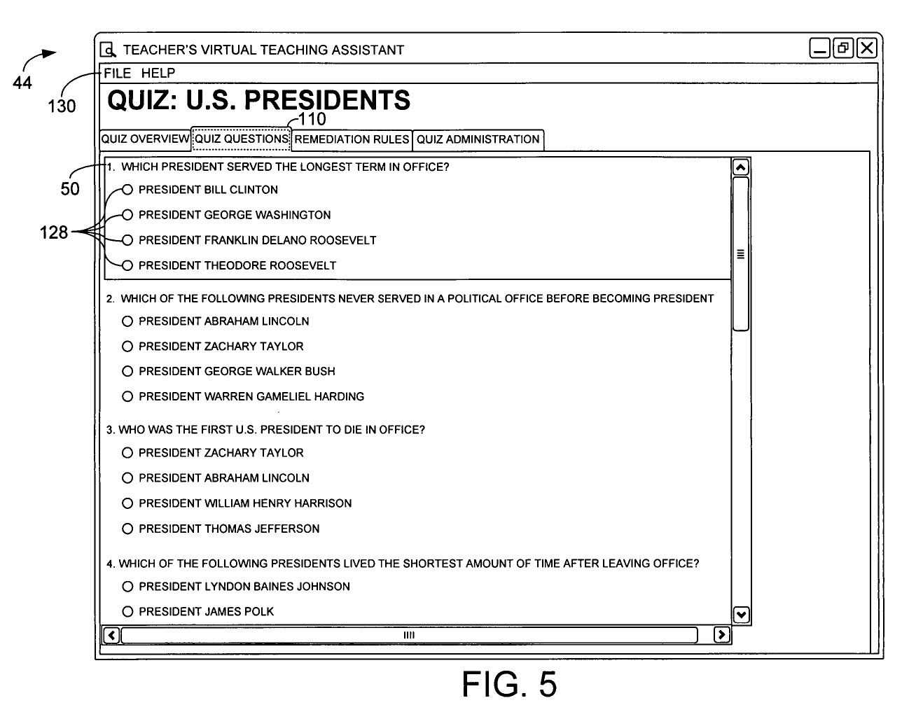

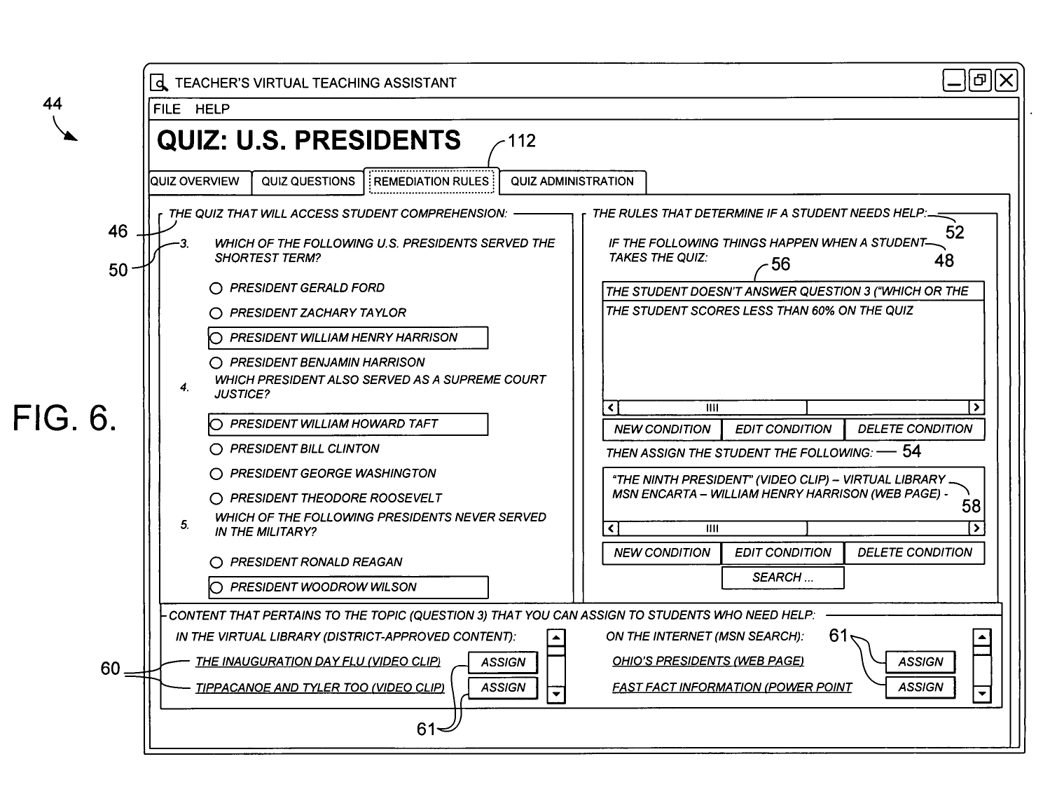

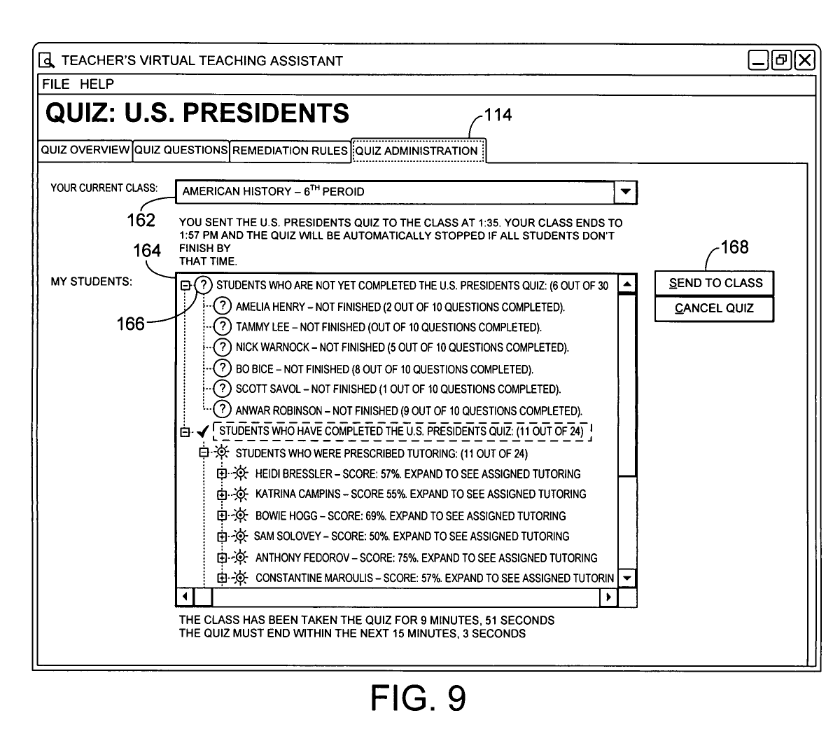

FIG. 4-6 and 9 show exemplary screen shots illustrating an assessment 44 on the VTA Teacher application 32. Referring now to FIG. 4-6 and 9, the creation of the assessment 44 will be discussed. The VTA Teacher Application is a window containing four tabs: the Quiz Overview 108 (FIG. 4), the Quiz Questions 110 (FIG. 5), the Remediation Rules 112 (FIG. 6), and the Quiz Administration 114 (FIG. 9). By selecting a tab, the teacher is able to maneuver within the VTA Teacher application 32 to create the assessment 44.

FIG. 4 shows an exemplary screen shot of the Quiz Overview 108 portion of the assessment 44 of the VTA Teacher application 32. The Quiz Overview 108 is where the teacher will enter such information about the quiz including but not limited to the title 116, the author 118, the description 120, the category 122, and the learning standard 124. The teacher may also check several boxes 126 that control whether or not the quiz may be shared with others. It should be noted that the title 116 is a required field while the remaining fields are optional.

The assessment 44 may be created using the VTA teacher application 32 via a Learning Management software application or may already exist in the VTA database 40. To create the questions 50 for the assessment 44 the teacher selects Quiz Questions 110. FIG. 5 shows an exemplary screen shot illustrating Quiz Questions 110. Some examples of the types of questions 50 include, but are not limited to, multiple choice, true/false, fill-in-the-blank, or text matching. The teacher must first click the Quiz Questions tab 110 to define the questions 50. The teacher has several options for defining the questions 50 that may be used in a quiz 45. However, these options are not meant to be limiting. First, a teacher can drag and drop the questions 50 and answers 128 from any suitable application that supports drag and drop. The teacher may also simply add the questions 50 and answers 128 into a text box in the Quiz Questions 110 portion by typing in the questions 50 and answers 128. Further, the teacher may also choose to open an existing quiz 45 or assessment 44 and import questions 50 therefrom.

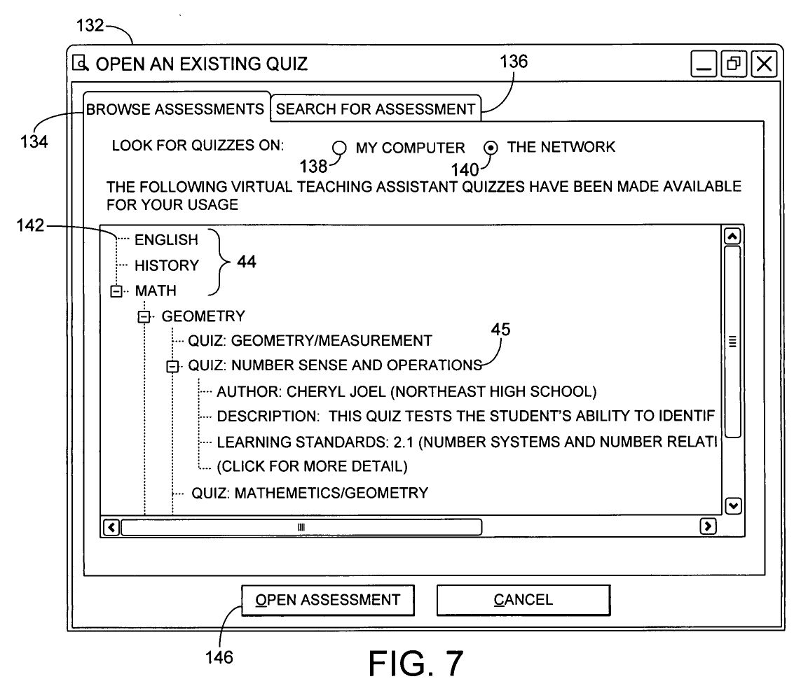

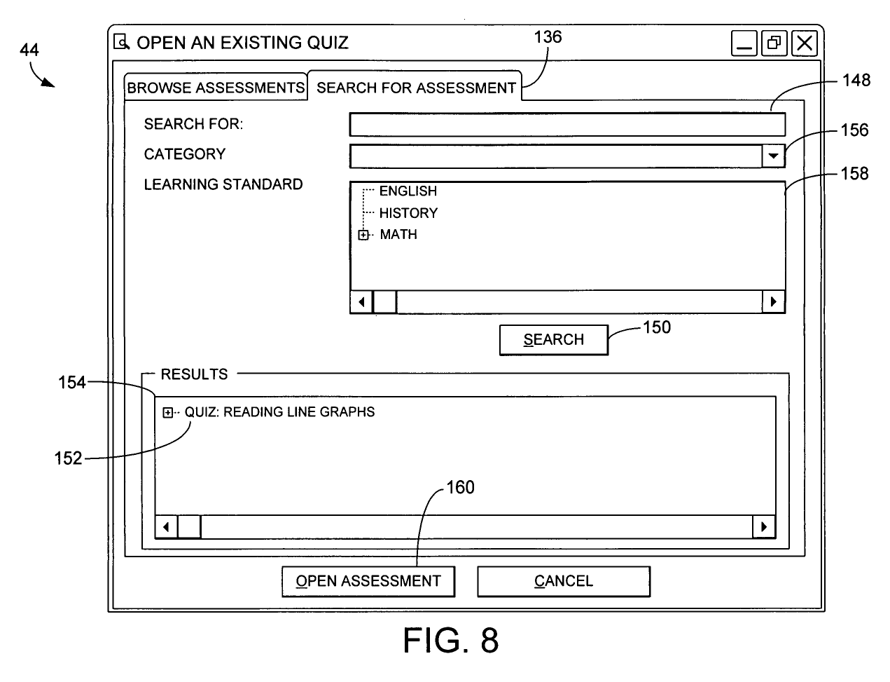

If the teacher chooses to open an existing quiz, the teacher will select FILE 130, and then open quiz, not shown, and an “open an existing quiz” window 132 will appear as shown in FIGS. 7 and 8. The “open an existing quiz” window 132 allows the user to either browse or search for the assessment 44 by selecting a Browse Assessment tab 134 or a Search Assessment tab 136. By clicking on the Browse Assessment tab 134 the teacher is allowed to browse for the quiz 45 or assessment 44. The user may browse the on his computer by selecting a My Computer option 138 or the network by selecting a Network option 140. If the My Computer option 138 is selected, the teacher will be provided with a traditional open file dialog, not shown, that will allow the teacher to select the quiz 45. If the teacher chooses the Network option 140, a hierarchical display 142 will show a listing of categories assessments 44 with the existing quizzes 45. Thus, if the teacher wishes to open the existing assessment 44, he may simply highlight the assessment 44 and select an “Open Assessment” button 146. Once open, the teacher may use the entire assessment 44 or select specific questions.

The teacher may also select the Search Assessment tab 136, which allow the teacher to search for the assessment 44 using a keyword search, by a category, or by a learning standard. If a keyword search is used, the teacher simply types the keyword into a search field 148 and selects a “search” button 150. The keyword search searches the fields of the quiz overview 108, specifically but not limited to the title 116, author 118, description 120, category 122, and learning standard 124 and displays a result 150 of the search in a results field 152. The teacher then selects an “Open Assessment” button 160 to open the assessment 44.

The teacher may also search by the category 122 in a category field 154 or by learning standard 124 in a learning standard field 156. It should be understood that the teacher searches in the category field 154 and learning standard field 156, presses the “search” button 150 and the results 150 are displayed the results field 152. Once the results 150 are displayed the results field 152, the teacher selects the “Open Assessment” button 160 to open the assessment 44.

Once the questions 50 of the assessment 44 have been defined, the teacher will select the Remediation Rules 112 tab. FIG. 6 shows an exemplary screen shot illustrating Remediation Rules 112 of the assessment 44 of the VTA Teacher application 32. As stated above, the assessment 44 consists of the Assessment Learning Resource 46 and a Remediation Criteria Set 48. The Assessment Learning Resource 46 is a reference to any form of the assessment 44. Some examples of Assessment Learning Resources 46 include but are not limited to the quiz 45 or the test. Specifically, the quiz 45 of FIG. 10 is created using the VTA Teacher application 32. As shown in FIGS. 5, 6, and 10, the assessment 44 and the quiz 45 include at least one question 50 that requires a response by the user or student.

Referring again to FIG. 6, the Remediation Criteria Set 48 is a group consisting of one or more Remediation Criteria Rules 52 and one or more Tutorial Directives 54 that are evaluated together. Together the Assessment Learning Resource 46 and the Remediation Criteria Set 48 provide information about the quiz 45 as well as which student responses will lead to a corresponding tutorial of instruction content being prescribed for the student as will be further discussed below. The Remediation Criteria Rule 52 includes one or more rules 56 that evaluate to a true/false value using logical operators based on a student's response to the assessment question 50. In other words, the rule 56 is evaluated against a response to an assessment question 50 to a value, the value being a true or a false. Each Remediation Criteria Rule 52 is used to evaluate the true/false value for each student taking each Assessment Learning Resource 46 defined in the VTA 30. The teacher can create an unbounded number of rules and the rules can range in complexity from very simple to very complex. The rules 56 determine the type of instructional content provided to students responding to the assessment 44 in a particular way.

Some examples of Remediation Criteria Rules 52 are as follows:

Rule Example #1: IF a student receives a score of less that 70%, assign the student educational content at link to Uniform Resource Locator (URL).

Rule Example #2: IF a student answers question #7 incorrectly AND answers question #12 incorrectly, assign the student the educational content at link to URL.

Rule Example #3: IF a student answers question #2 incorrectly AND answers question #7 incorrectly AND leaves either question #14 or question #15 unanswered, assign the student the educational content at link to URL.

Rule Example #4: IF a student answers question #5 incorrectly OR answers question #13 incorrectly OR receives a total score of less than 75% OR leaves more than two questions unanswered, assign the student the educational content at link to URL.

The above example are merely for illustrative purposes and should not be viewed as limiting in any way. As should be understood, the rules that can be defined are virtually limitless.

Once the value is derived from the Remediation Criteria Rule 52, at least one Tutorial Directive 54 is assigned to the student. The Tutorial Directive 54 is an assignment 58 given to a student in response to the student's response to the assessment 44. The assignment 58 is expressed in the form of a reference or link 60 to a URL. The link 60 provides access to educational content and materials designed to reinforce a learning objective. The links 60 may already exist if an existing assessment 44 is used. Alternatively, if the teacher creates the assessment 44, the teacher may search for links that are appropriate for the material tested in the assessment 44. To choose the link 60 for the assignment 58, the teacher simply select the “assign” button 61.

Once the teacher has created the assessment 44, the teacher selects Quiz Administration 114. FIG. 9 shows an exemplary screen shot illustrating the Quiz Administration 114. At this time the assessment 44 is ready to be sent to the students. The Quiz Administration 114 portion contains a “class selection” field 162 that shows the current class for the teacher and a “my students” field 164 that shows a list 166 of each student enrolled in the current class. Once the teacher has selected the current class and an assessment 44 is loaded, the teacher selects a “send to class” button 168 in order to send the quiz 45 to the class. As further shown in FIG. 9, once the quiz 45 is sent, the list 166 shows the progress of each individual student taking the quiz 45.

FIG. 10 shows an exemplary screen shot illustrating a quiz 45 sent to a student. Once the assessment 44 is sent the dialog box 78 appears with the quiz 45. The dialog box 78 contains a number of questions 50 with corresponding boxes 82 that may be checked by the student. The boxes 82 correspond to the Tutorial Directive 54 made available by the teacher in the VTA 30. The boxes 82 allow the student to choose whether he would like to receive the instructional content immediately or at a later time.

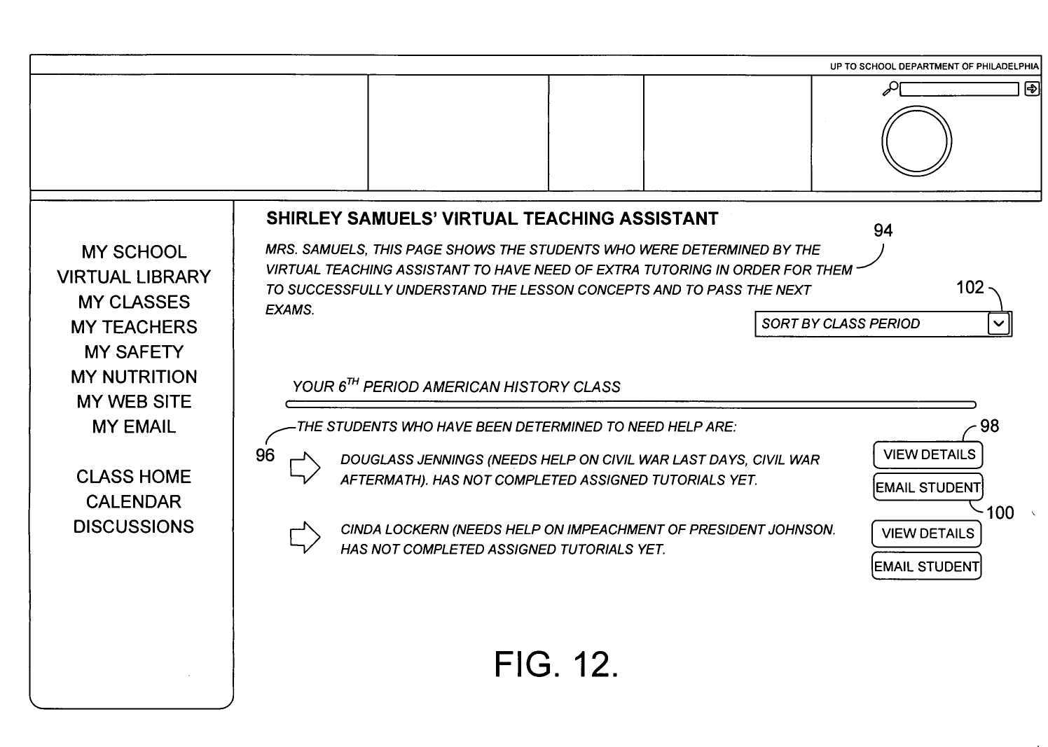

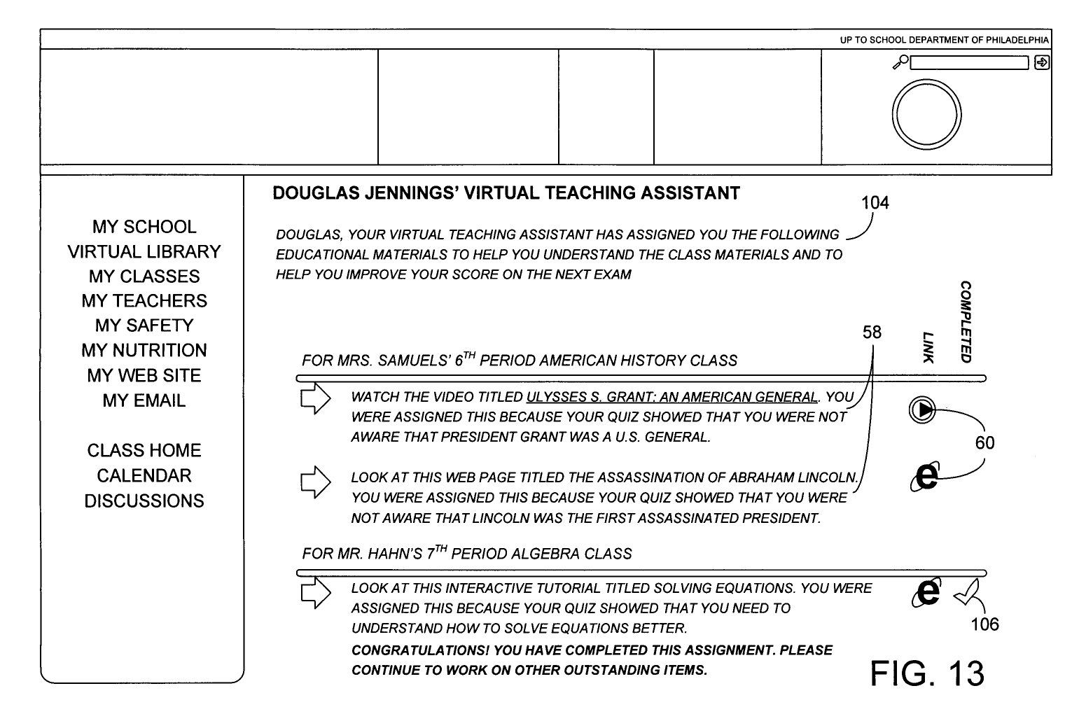

As shown in FIGS. 12 and 13 and as discussed above both the teacher and students will receive a report 94, 104. The teacher will receive the report 94 in the VTA teachers application 32. The report 94 shows a list 96 of which students are automatically assigned tutorials based on the Remediation Criteria, and which tutorials are being assigned to which student. A “view details” button 98 is shown where, if selected, allows the teacher access to a list of students who have completed reviewing the tutorial material and their responses for how they were helped or not helped by the material, as well as the list of students who have not yet completed their review of the assigned tutorial materials. An “email student” button 100 is also included that allow the teacher to communicate with the student. A drop-down menu 102 is shown that allows for multiple sorting options. Some options may include but are not limited to sort by class period, class type or grade.

As shown in FIG. 13, each student will also be presented with the report 104 in the VTA student application 34. The report 104 will include the assigned tutorial materials 58 from each class based on the Remediation Criteria. As stated above, the assignment 58 is expressed in the link 60 provided on the report 104. The link 60 provides access to educational content and materials designed to reinforce a learning objective. Further once the student has completed a review of the assignment 58 in the link 60 a checkmark 106 will appear indicating such.

From the foregoing it will be appreciated that, although specific embodiments have been described herein for purposes of illustration, various modifications may be made without deviating from the spirit and scope. Accordingly, the invention is not limited except as by the appended claims.

1. A computer-implemented instruction method in a computer network environment, the method comprising:
providing at least one assessment with at least one set of remediation criteria;
communicating said at least one assessment to at least one recipient;
receiving at least one response from said at least one recipient;
generating an indication of learning comprehension for each of said at least one recipient based on a comparison of said at least one received response and said remediation criteria set; and
assigning at least one tutorial to said at least recipient based on the indication of learning comprehension for that recipient.

2. The method of claim 1, wherein said assessment exists in said network environment.

3. The method of claim 2, wherein said providing at least one assessment includes creating said assessment by copying said assessment from a preexisting assessment in said network environment.

4. The method of claim 3, wherein said providing at least one assessment includes creating said assessment by editing said preexisting assessment in said network environment.

5. The method of claim 4, wherein the assessment is a quiz.

6. The method of claim 1, wherein said at least one set of remediation criteria includes at least one rule and at least one directive.

7. The method of claim 6, wherein said at least one rule evaluates to a true/false value using a logical operator.

8. The method of claim 7, wherein said at least one directive assigns said at least one tutorial based on said true/false value.

9. A computer-implemented method for assessing comprehension of one or more recipients, the method comprising:
creating an assessment;
associating at least one remediation criteria with said assessment;
communicating said assessment to at least one recipient;
receiving feedback from said at least one recipient;
comparing said feedback with said at least one remediation criteria; and
assigning a tutorial based on said comparison.

10. The method of claim 9, wherein said creating said assessment includes copying said assessment from a preexisting assessment.

11. The method of claim 10, wherein said creating said assessment includes editing said preexisting assessment.

12. The method of claim 11, wherein said at least one set of remediation criteria includes at least one rule and at least one directive.

13. The method of claim 12, wherein the rule evaluates to a true/false value using a logical operator.

14. The method of claim 13, wherein the directive assigns the tutorial based on the true/false value.

15. The method of claim 14, wherein the assessment is a quiz

16. A system for assessing comprehension in, the system comprising:
at least one teaching module; said at least one teaching module being adapted to send output to and receive input from an external source; and
a database;
wherein based upon the input received, the teaching module will assign at least one tutorial to said external source.

17. The system of claim 16, wherein said output sent from said teaching module is an assessment having remediation criteria.

18. The system of claim 17, wherein said assessment resides in said database.

19. The system of claim 18, wherein said external source is at least one student module.

20. The system of claim 19, wherein the input received from said at least one student module is compared with said remediation criteria and wherein said at least one tutorial is assigned based on said comparison.
